(19) United States
(12) Patent Application Publication
(10) Pub. No.: US 2025/0206026 A1
(43) Pub. Date: Jun. 26, 2025

(54) LIQUID EJECTING DEVICE

(71) Applicant: SEIKO EPSON CORPORATION, Tokyo (JP)

(72) Inventors: Shoji AKATSU, SHIOJIRI-SHI (JP); Daiki ISHIKAWA, SHIOJIRI-SHI (JP)

(21) Appl. No.: 18/987,768

(22) Filed: Dec. 19, 2024

(30) Foreign Application Priority Data
Dec. 22, 2023 (JP) 2023-217114

(51) Int. Cl. B41J 2/175; B41J 29/54

(52) U.S. Cl. CPC B41J 2/17523; B41J 2/17526; B41J 2/17553; B41J 29/54

(57) ABSTRACT

A liquid ejecting device that includes a main body at which a liquid ejecting unit is mounted, a liquid supply device configured to be movable independently of the main body and supply liquid to the liquid ejecting unit, a main body side engaging portion configured to engage with the liquid supply device, and a liquid supply device side engaging portion configured to engage with the main body, wherein one of the main body side engaging portion and the liquid supply device side engaging portion includes an insertion portion formed of a conductive member and movable in a vertical direction, another includes an accommodating portion for accommodating the insertion portion, and the accommodating portion is provided with a contact member formed of a conductive member, and configured to accommodate the insertion portion in a state in which the contact member and the insertion portion are in contact with each other.

The present application is based on, and claims priority from JP Application Serial Number 2023-217114, filed Dec. 22, 2023, the disclosure of which is hereby incorporated by reference herein in its entirety.

### BACKGROUND

### 1. Technical Field

The present disclosure relates to a liquid ejecting device.

### 2. Related Art

In the past, various types of liquid ejecting devices have been used. Among them, there is a liquid ejecting device configured such that a main body that ejects liquid and a liquid supply device that supplies the liquid to the main body are movable. For example, JP 2020-199700 A discloses a printer system including a printer that performs printing by ejecting ink, and a liquid supply device that supplies the ink to the printer, in which the printer and the liquid supply device are coupled with a plurality of tubes and are configured to be movable.

In an existing liquid ejecting device in which a main body and a liquid supply device are configured to be movable as in the printer system of JP 2020-199700 A, for example, when the liquid ejecting device is moved, or the like, there was a risk that the main body and the liquid supply device are so far away from each other that a liquid supply path such as a tube is damaged, or there was a risk that the main body and the liquid supply device are too close to each other to collide with each other. In addition, there are cases where it is necessary to ensure conduction between the liquid supply device and the main body.

### SUMMARY

A liquid ejecting device according to the present disclosure for solving the above-described problems includes a liquid ejecting unit configured to eject liquid, a main body at which the liquid ejecting unit is mounted, a liquid supply device configured to be movable independently of the main body and supply the liquid to the liquid ejecting unit via a liquid supply path, a main body side engaging portion provided at the main body and configured to engage with the liquid supply device, and a liquid supply device side engaging portion provided at the liquid supply device and configured to engage with the main body, wherein one of the main body side engaging portion and the liquid supply device side engaging portion includes an insertion portion formed of a conductive member and movable in a vertical direction, another of the main body side engaging portion and the liquid supply device side engaging portion includes an accommodating portion for accommodating the insertion portion, and the accommodating portion is provided with a contact member formed of a conductive member, and configured to accommodate the insertion portion in a state in which the contact member and the insertion portion are in contact with each other.

### BRIEF DESCRIPTION OF THE DRAWINGS

FIG. 1 is a schematic side view of a liquid ejecting device according to an example of the present disclosure.

FIG. 2 is a perspective view of the liquid ejecting device in FIG. 1.

FIG. 3 is a perspective view of a periphery of a position in a main body of the liquid ejecting device in FIG. 1 where a liquid supply device is installed.

FIG. 4 is a perspective view of the liquid supply device attached to the main body of the liquid ejecting device in FIG. 1.

FIG. 5 is a perspective view of a periphery of engaging portions for engaging the main body in the liquid ejecting device and the liquid supply device in FIG. 1.

FIG. 6 is an enlarged perspective view of a part of the engaging portions in FIG. 5.

### DESCRIPTION OF EMBODIMENTS

First, the present disclosure will be schematically described.

A liquid ejecting device according to a first aspect of the present disclosure for solving the above-described problems includes a liquid ejecting unit configured to eject liquid, a main body at which the liquid ejecting unit is mounted, a liquid supply device configured to be movable independently of the main body and supply the liquid to the liquid ejecting unit via a liquid supply path, a main body side engaging portion provided at the main body and configured to engage with the liquid supply device, and a liquid supply device side engaging portion provided at the liquid supply device and configured to engage with the main body, wherein one of the main body side engaging portion and the liquid supply device side engaging portion includes an insertion portion formed of a conductive member and movable in a vertical direction, another of the main body side engaging portion and the liquid supply device side engaging portion includes an accommodating portion for accommodating the insertion portion, and the accommodating portion is provided with a contact member formed of a conductive member, and configured to accommodate the insertion portion in a state in which the contact member and the insertion portion are in contact with each other.

According to the aspect, one of the main body side engaging portion and the liquid supply device side engaging portion includes the insertion portion formed of a conductive member and movable in the vertical direction, and the other of the main body side engaging portion and the liquid supply device side engaging portion includes the accommodating portion that accommodates the insertion portion in the state in which the contact member formed of a conductive member and the insertion portion are in contact with each other. With such a configuration, when the accommodating portion accommodates the insertion portion, the insertion portion can be brought into contact with the contact member according to gravity, thus it is easy to maintain contact with the contact member and obtain conduction, and it is possible to appropriately maintain a position of the liquid supply device with respect to the main body while ensuring conduction between the liquid supply device and the main body.

The liquid ejecting device according to a second aspect of the present disclosure is an aspect dependent on the first aspect, wherein the accommodating portion includes an opening in the vertical direction, and is configured such that the contact member and the insertion portion come into contact with each other by the insertion portion being inserted into the opening.

According to the aspect, the accommodating portion includes the opening in the vertical direction, and is configured such that the contact member and the insertion portion come into contact with each other by the insertion portion being inserted into the opening. With such a configuration, it is possible to simplify the configuration of the accommodating portion, and it is possible to appropriately maintain the position of the liquid supply device with respect to the main body while suitably ensuring conduction between the liquid supply device and the main body.

The liquid ejecting device according to a third aspect of the present disclosure is an aspect dependent on the first or second aspect, wherein the main body side engaging portion includes the insertion portion, and the liquid supply device side engaging portion includes the accommodating portion.

According to the aspect, the main body side engaging portion includes the insertion portion, and the liquid supply device side engaging portion includes the accommodating portion. In many cases, the liquid supply device is moved more frequently than the main body, but as described above, by providing the insertion portion at the main body side engaging portion and the accommodating portion at the liquid supply device side engaging portion, it is easy to reduce the liquid supply device in size and weight, which is moved more frequently.

The liquid ejecting device according to a fourth aspect of the present disclosure is an aspect dependent on the first or second aspect that includes a first locking member disposed so as to be spaced from the insertion portion at one of the main body side engaging portion and the liquid supply device side engaging portion, and extending in the vertical direction, and a second locking member disposed so as to be spaced from the accommodating portion at the other of the main body side engaging portion and the liquid supply device side engaging portion and configured such that movement relative to the first locking member is locked.

According to the aspect, the first locking member and the second locking member are provided so as to be spaced from the insertion portion and the accommodating portion. For this reason, it is possible to position the main body and the liquid supply device at two locations spaced from each other, and it is possible to prevent the liquid supply device from moving with respect to the main body in a rotating direction with the vertical direction as a rotation axis.

The liquid ejecting device according to a fifth aspect of the present disclosure is an aspect dependent on the fourth aspect, wherein the first locking member and the second locking member are configured to come into contact with each other to regulate separation of the main body and the liquid supply device.

According to the aspect, the first locking member and the second locking member are configured to come into contact with each other to regulate the separation of the main body and the liquid supply device. With such a configuration, it is possible to easily and effectively prevent the liquid supply device from moving in the rotating direction with respect to the main body.

The liquid ejecting device according to a sixth aspect of the present disclosure is an aspect dependent on the fourth aspect, wherein surface treatment methods for the insertion portion and the first locking member are different from each other.

According to the aspect, the surface treatment methods for the insertion portion and the first locking member are different from each other. Since required characteristics are not necessarily common to the insertion portion and the first locking member, by adopting such a configuration, it is possible to perform suitable surface treatment according to characteristics required for each of the insertion portion and the first locking member.

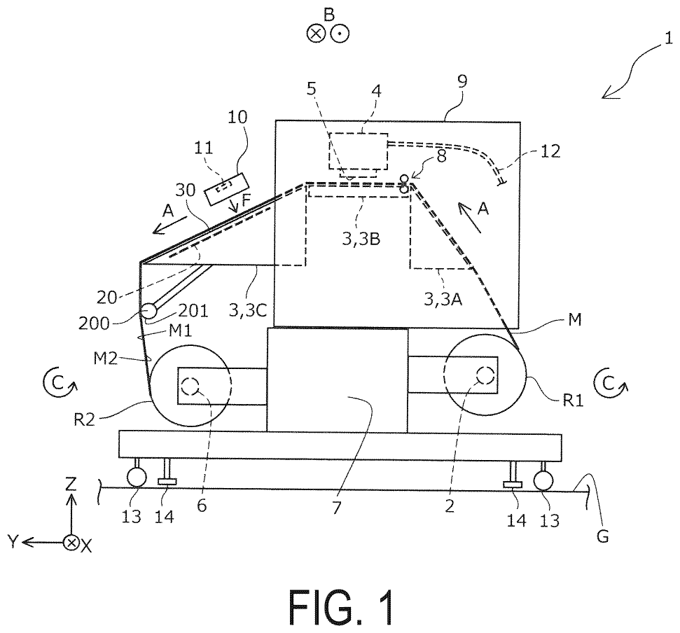

Below, embodiments according to the present disclosure will be specifically described with reference to the drawings. First, an overview of a liquid ejecting device 1 according to an example of the present disclosure will be given mainly with reference to FIG. 1. Referring to FIG. 1, some constituent members are simplified and omitted for easy understanding of the configuration. Here, in FIG. 1, an X-axis direction in the drawing is a horizontal direction and a direction in which s support portion of a supply unit 2 that holds a roll body R1 obtained by winding a medium M into a roll shape, a Y-axis direction is a horizontal direction, a front-and-rear direction of the liquid ejecting device 1, and a direction orthogonal to the X-axis direction, and a Z-axis direction is a vertical direction. Further, hereinafter, it is assumed that an arrow direction is a + direction, and a direction opposite to the arrow direction is a − direction. For example, in FIG. 1, it is assumed that a vertically upward direction is a +Z direction, a vertically downward direction is a −Z direction, a forward direction of the liquid ejecting device 1 is a +Y direction, and a rearward direction of the liquid ejecting device 1 is a −Y direction.

As illustrated in FIG. 1, the liquid ejecting device 1 according to the example includes a main body 9, and leg frames 7 are attached to portions near both ends of the main body 9 in the X-axis direction. Note that the main body 9 can also be regarded as including the supply unit 2, the leg frame 7, a medium support portion 3, a winding unit 6, and the like, which will be described later. Casters 13 and adjusters 14 are provided below the leg frames 7, the liquid ejecting device 1 can be easily moved using the casters 13, and the liquid ejecting device 1 can be suitably installed at an installation surface G by adjusting heights of a plurality of locations using the adjusters 14. Further, the liquid ejecting device 1 according to the example includes the supply unit 2 that holds the roll body R1 on the −Y direction side, which corresponds to a rear side of the main body 9. The supply unit 2 supports a paper tube of the roll body R1 around which the medium M is wound so as to sandwich the paper tube in the X-axis direction, and supplies the medium M to a position facing a head 5 as a liquid ejecting unit.

Then, in the liquid ejecting device 1 according to the example, when the medium M is transported in a transport direction A, the supply unit 2 rotates the roll body R1 in a rotating direction C. Referring to FIG. 1, the roll body R1 wound so that an image forming surface M1 on which an image is formed is on an outer side is used, but when the roll body R1 wound so that the image forming surface M1 is on an inner side is used, the supply unit 2 can rotate the roll body R1 in a direction opposite to the rotating direction C to feed the medium M.

Further, the liquid ejecting device 1 according to the example includes a transport path of the medium M including the medium support portion 3 that supports the medium M at a support face 30. The liquid ejecting device 1 according to the example includes, as the medium support portion 3, an upstream medium support portion 3A, a medium support portion 3B, and a downstream medium support portion 3C from upstream to downstream in the transport direction A. Further, the liquid ejecting device 1 further includes a roller pair 8 including a driving roller and a driven roller as a transport unit for transporting the medium M in the transport direction A on the transport path. However, the configuration of the transport unit is not specifically limited.

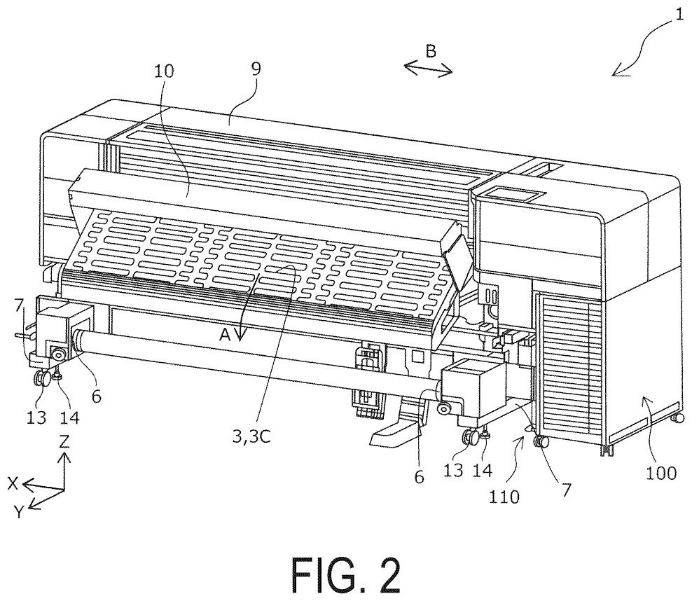

Further, the liquid ejecting device 1 according to the example includes the head 5 and a carriage 4 at a position facing the medium support portion 3B. The head 5 is a liquid ejecting unit that is provided with a plurality of nozzles and forms an image by ejecting ink being liquid from the nozzles. The carriage 4 is mounted with the head 5 and is reciprocally movable in a width direction B. A liquid supply path 12 formed of a tube or the like is coupled to the head 5, and the ink is supplied to the head 5 via the liquid supply path 12 from an ink cartridge attached to a liquid supply device 100 illustrated in FIG. 2 or the like, which will be described in detail later. In the liquid ejecting device 1 according to the example, the transport direction A at a position facing the head 5 at the medium support portion 3B is the +Y direction, the width direction B, which is a moving direction of the head 5, is a direction along the X-axis direction, and an ejecting direction of the ink is the −Z direction.

With the configuration described above, the head 5 can form an image by ejecting the ink from the nozzles (not illustrated) onto the transported medium, while reciprocating in the width direction B as a direction intersecting the transport direction A. The liquid ejecting device 1 according to the example can form a desired image on the medium M by repeating transport of the medium M by a predetermined transport amount in the transport direction A and ejection of the ink in a state in which the medium M is stopped while the head 5 moves in the width direction B.

Further, the downstream medium support portion 3C of the medium support portion 3 is provided with a heater 20 as a heating unit for heating a supported face M2 opposite to the image forming surface M1 of the medium M. The heater 20 according to the example is constituted by an electric heating wire and the like but is not limited to such a configuration. Further, not only the downstream medium support portion 3C but also the upstream medium support portion 3A or the medium support portion 3B may be provided with a medium heating unit that heats the supported face M2 opposite to the image forming surface M1 of the medium M.

Furthermore, an air blowing unit 10 that dries the ink ejected from the head 5 to the image forming surface M1 of the medium M by blowing an airflow F is provided at a portion facing the downstream medium support portion 3C in the transport path. The air blowing unit 10 according to the example includes a fan 11 that generates the airflow F and is configured to be able to blow a gas as the airflow F to the image forming surface M1 of the medium M, but is not limited to such a configuration.

Further, the winding unit 6 is provided downstream of the downstream medium support portion 3C in the transport direction A. The winding unit 6 winds the medium M transported in the transport direction A into a roll shape to obtain a roll body R2. Note that in the liquid ejecting device 1 according to the example, the supply unit 2 and the winding unit 6 have the same configuration. The medium M transported from the supply unit 2 to the winding unit 6 is transported in a state in which a predetermined tension is applied by the winding unit 6 or the like. The winding unit 6 supports a paper tube that is a winding core of the roll body R2 so as to sandwich the paper tube in the X-axis direction, and winds the medium M in a roll shape by rotating the paper tube. Referring to FIG. 1, when the winding unit 6 rotates the roll body R2 in the rotating direction C, winding is performed so that the image forming surface M1 faces outward. However, the medium M may be wound so that the image forming surface M1 faces inward. In such a case, the winding unit 6 rotates the roll body R2 in the direction opposite to the rotating direction C.

Note that a guide bar 200 is provided between the downstream medium support portion 3C and the winding unit 6 in the transport direction A. The guide bar 200 includes a contact surface 201 having an arc shape when viewed from the width direction B. Then, the guide bar 200 guides the transport of the medium M when the contact surface 201 comes into contact with the supported face M2 of the medium M wound by the winding unit 6. However, the configuration of the guide bar 200 is not particularly limited, and further, a configuration may be adopted that does not include the guide bar 200.

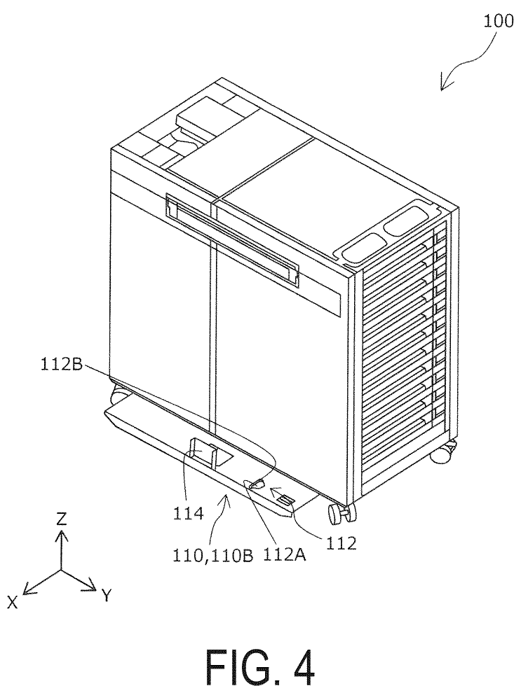

As described above, the liquid ejecting device 1 according to the example includes the head 5 that ejects ink, and the head 5 is mounted at the main body 9. Then, the liquid ejecting device 1 according to the example includes the liquid supply device 100 that supplies the ink to the head 5. Hereinafter, details of the liquid supply device 100 and an engaging portion 110 between the main body 9 and the liquid supply device 100 will be described mainly with reference to FIGS. 2 to 6.

As illustrated in FIGS. 2 to 4, and the like, the liquid supply device 100 according to the example is configured to be movable independently of the main body 9, and is configured to be capable of supplying ink to the head 5 via the liquid supply path 12. In the liquid supply device 100, a plurality of ink cartridges into which ink is injected can be mounted, and the plurality of ink cartridges can be coupled to a plurality of the liquid supply paths 12 provided corresponding to the respective ink cartridges. Then, in the liquid ejecting device 1 according to the example, the ink of each of the plurality of ink cartridges can be ejected from the head 5 onto the image forming surface M1 of the transported medium M.

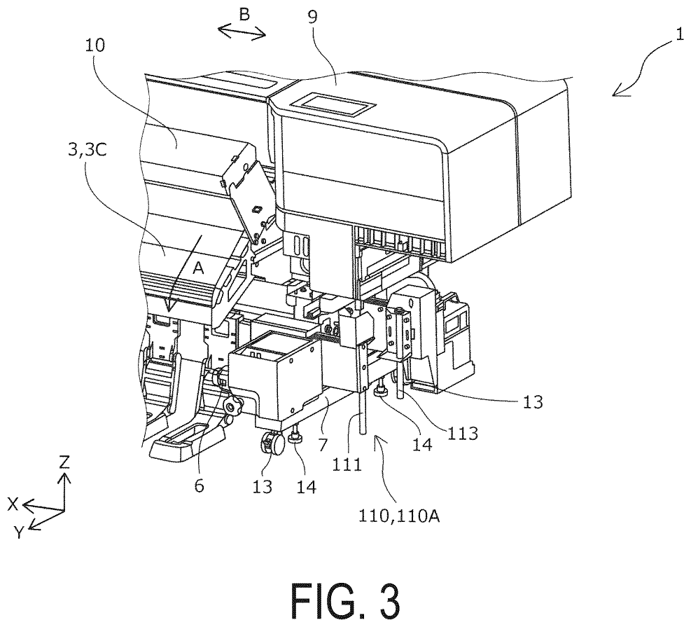

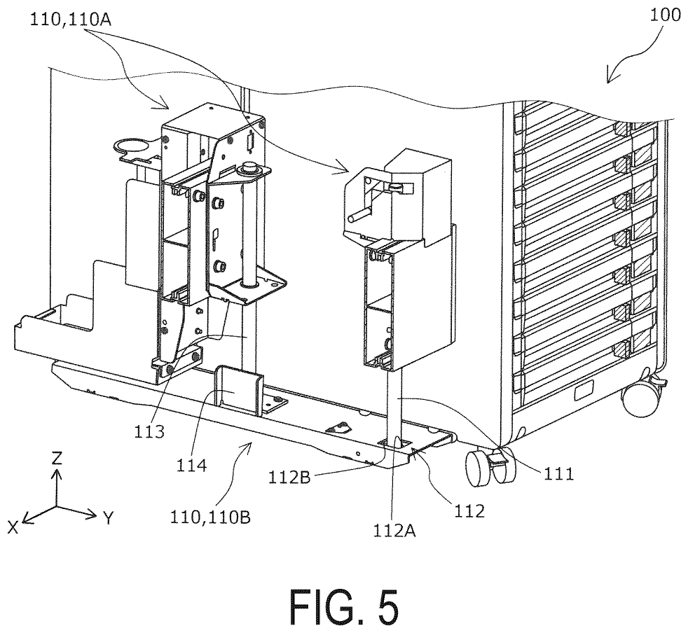

Additionally, as illustrated in FIGS. 2 to 5, the engaging portion 110 includes a main body side engaging portion 110A provided at the main body 9 and capable of engaging with the liquid supply device 100, and a liquid supply device side engaging portion 110B provided at the liquid supply device 100 and capable of engaging with the main body 9. Then, as illustrated in FIGS. 3 and 5, the main body side engaging portion 110A includes an insertion portion 111 movable in the vertical direction (Z-axis direction), and the liquid supply device side engaging portion 110B includes an accommodating portion 112 that accommodates the insertion portion 111. By configuring the insertion portion 111 to be movable in the vertical direction, it is possible to maintain an engagement state between the main body side engaging portion 110A and the liquid supply device side engaging portion 110B even when a positional relationship between the main body 9 and the liquid supply device 100 in the vertical direction varies due to a state change of the installation surface G, height adjustment by the adjuster 14, or the like.

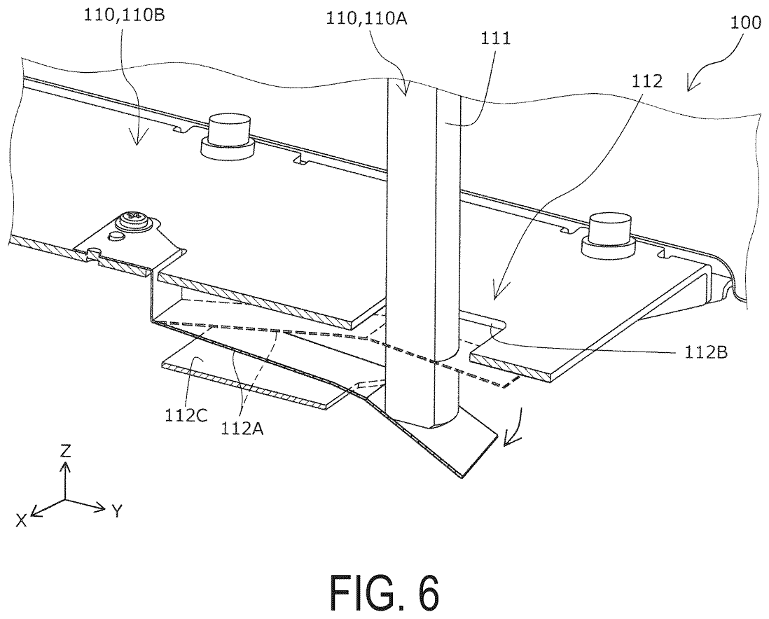

Here, as illustrated in FIG. 6, the accommodating portion 112 is provided with a contact member 112A in a plate spring shape that comes into contact with the insertion portion 111 when the insertion portion 111 is accommodated, and a sheet metal portion 112C with which the contact member 112A pressed from a vertically upward direction to a vertically downward direction comes into contact when the insertion portion 111 is accommodated. That is, the accommodating portion 112 is configured to be able to accommodate the insertion portion 111 in a state in which the contact member 112A and the insertion portion 111 are in contact with each other. Note that before the insertion portion 111 is inserted into an opening portion 112B of the accommodating portion 112, the contact member 112A in the plate spring shape is in posture indicated by a broken line in FIG. 6, and does not come into contact with the sheet metal portion 112C, and when the insertion portion 111 is inserted into the opening portion 112B, the contact member 112A in the plate spring shape is in posture indicated by a solid line in FIG. 6 and comes into contact with the sheet metal portion 112C.

Further, the insertion portion 111, the liquid supply device side engaging portion 110B, and the sheet metal portion 112C are made of metal. Then, any of the insertion portion 111, the liquid supply device side engaging portion 110B, and the sheet metal portion 112C has a conductive metal surface, is metal-plated, and is a conductive member. Therefore, when the accommodating portion 112 accommodates the insertion portion 111, the liquid supply device 100 and the main body 9 are electrically coupled to each other.

The liquid ejecting device 1 may be configured such that, one of the main body side engaging portion 110A and the liquid supply device side engaging portion 110B includes the insertion portion 111 formed of a conductive member and movable in the vertical direction, and another of the main body side engaging portion 110A and the liquid supply device side engaging portion 110B includes the accommodating portion 112 that accommodates the insertion portion 111 in the state in which the contact member 112A formed of a conductive member and the insertion portion 111 are in contact with each other. Because, with such a configuration, when the accommodating portion 112 accommodates the insertion portion 111, the insertion portion 111 can be brought into contact with the contact member 112A according to gravity, it is easy to maintain contact with the contact member 112A and obtain conduction, and it is possible to appropriately maintain a position of the liquid supply device 100 with respect to the main body 9 while ensuring conduction between the liquid supply device 100 and the main body 9. Note that by appropriately maintaining the position of the liquid supply device 100 with respect to the main body 9, for example, even when the liquid ejecting device 1 is moved, it is possible to move the liquid supply device 100 so as to follow the main body 9, and it is possible to reduce a risk that the liquid supply path 12 is damaged due to the main body 9 and the liquid supply device 100 being too far away from each other, or a risk that the main body 9 and the liquid supply device 100 are too close to each other and collide with each other.

Here, as described above, the liquid ejecting device 1 according to the example includes the insertion portion 111 at the main body side engaging portion 110A and includes the accommodating portion 112 at the liquid supplying device side engaging portion 110B, but may be configured to include the accommodating portion 112 at the main body side engaging portion 110A and include the insertion portion 111 at the liquid supply device side engaging portion 110B. However, particularly, as in the case of the engaging portion 110 according to the example, the main body side engaging portion 110A may include the insertion portion 111 and the liquid supply device side engaging portion 110B may include the accommodating portion 112. Because in many cases, the liquid supply device 100 is moved more frequently than the main body 9, but with such a configuration, it is easy to reduce the liquid supply device 100 in size and weight, which is moved more frequently.

In addition, as illustrated in FIG. 6 and the like, the accommodating portion 112 of the engaging portion 110 according to the example includes the opening portion 112B that is open in the vertical direction, and a configuration is adopted in which the contact member 112A and the insertion portion 111 come into contact with each other by the insertion portion 111 being inserted into the opening portion 112B. By being inserted into the opening portion 112B, movement of the insertion portion 111 in the horizontal direction is restricted. Since the liquid ejecting device 1 according to the example has such a configuration, the configuration of the accommodating portion 112 can be simplified, and it is possible to appropriately maintain the position of the liquid supply device 100 with respect to the main body 9 while suitably securing conduction between the liquid supply device 100 and the main body 9.

Further, the engaging portion 110 of the liquid ejecting device 1 is provided with a rod-shaped first locking member 113 extending in the vertical direction and a wall-shaped second locking member 114 capable of regulating movement of the first locking member 113 in a +X direction that are spaced from the insertion portion 111 and the accommodating portion 112 in the Y-axis direction. As described above, the first locking member 113 disposed so as to be spaced from the insertion portion 111 and extending in the vertical direction may be included at the one of the main body side engaging portion 110A and the liquid supply device side engaging portion 110B, and the second locking member 114 disposed so as to be spaced from the accommodating portion 112 and configured such that movement relative to the first locking member 113 is locked may be included at the other of the main body side engaging portion 110A and the liquid supply device side engaging portion 110B.

Because, with such a configuration, the main body 9 and the liquid supply device 100 can be positioned at two locations spaced from each other, and it is possible to prevent the liquid supply device 100 from moving with respect to the main body 9 in the rotating direction with the vertical direction as the rotation axis, specifically, to prevent the liquid supply device 100 from rotating with respect to the main body 9 with the insertion portion 111 extending in the vertical direction as the rotation axis. Note that in the engaging portion 110 according to the example, the main body side engaging portion 110A is provided with the rod-shaped first locking member 113, and the liquid supply device side engaging portion 110B is provided with the wall-shaped second locking member 114, but a configuration may be adopted in which the main body side engaging portion 110A is provided with the wall-shaped second locking member 114, and the liquid supply device side engaging portion 110B is provided with the rod-shaped first licking member 113. Furthermore, the configurations of the first locking member 113 and the second locking member 114 are not particularly limited, and the first locking member 113 may be configured to have a shape other than a rod shape, and the second locking member 114 may be configured to have a shape other than a wall shape.

Specifically, as illustrated in FIG. 5 and the like, the first locking member 113 and the second locking member 114 according to the example are configured to regulate separation of the main body 9 and the liquid supply device 100 by the rod-shaped first locking member 113 extending in the vertical direction (Z-axis direction) and the wall-shaped second locking member 114 located farther on the +X direction side than the first locking member 113 coming into contact with each other. By configuring the first locking member 113 and the second locking member 114 as described above, it is possible to easily and effectively prevent the liquid supply device 100 from moving in the rotating direction with respect to the main body 9.

In addition, in the engaging portion 110 according to the example, both the insertion portion 111 and the first locking member 113 are subjected to surface treatment by metal plating. However, the surface treatment methods for the insertion portion 111 and the first locking member 113 may be different from each other. Since required characteristics are not necessarily common to the insertion portion 111 and the first locking member 113, by performing surface treatment differently for the insertion portion 111 and the first locking member 113, it is possible to perform suitable surface treatment according to characteristics required for each of the insertion portion 111 and the first locking member 113.

As described above, in the engaging portion 110 according to the example, while both the insertion portion 111 and the first locking member 113 are subjected to the surface treatment by metal plating, the second locking member 114 is formed of metal but a surface thereof is coated with a non-conductive coating material. Therefore, the insertion portion 111 and the accommodating portion 112 are electrically coupled to each other, but the first locking member 113 and the second locking member 114 are not electrically coupled to each other. However, a configuration may be adopted in which the first locking member 113 and the second locking member 114 are electrically coupled to each other by performing the surface treatment by metal plating for the second locking member 114. Further, as long as the configuration is adopted in which the first locking member 113 and the second locking member 114 are not electrically coupled to each other, the first locking member 113 may be subjected to surface treatment by coating with a non-conductive paint or the like.

The present disclosure is not limited to the example described above, and can be realized in various configurations without departing from the spirit of the present disclosure. Further, technical characteristics in the example corresponding to the technical characteristics in each form described in the SUMMARY can be substituted or combined appropriately to solve some or all of the above-described problems, or to achieve some or all of the above-described effects. Furthermore, when the technical characteristics are not described as being essential in the present specification, the technical characteristics can be deleted as appropriate.

What is claimed is:

1. A liquid ejecting device, comprising:
a liquid ejecting unit configured to eject liquid;
a main body at which the liquid ejecting unit is mounted;
a liquid supply device configured to move independently of the main body and supply the liquid to the liquid ejecting unit via a liquid supply path;
a main body side engaging portion provided at the main body and configured to engage with the liquid supply device; and
a liquid supply device side engaging portion provided at the liquid supply device and configured to engage with the main body, wherein
one of the main body side engaging portion and the liquid supply device side engaging portion includes an insertion portion formed of a conductive member and configured to move in a vertical direction,
another of the main body side engaging portion and the liquid supply device side engaging portion includes an accommodating portion for accommodating the insertion portion, and
the accommodating portion is provided with a contact member formed of a conductive member, and configured to accommodate the insertion portion in a state in which the contact member and the insertion portion are in contact with each other.

2. The liquid ejecting device according to claim 1, wherein
the accommodating portion includes an opening in the vertical direction, and is configured such that the contact member and the insertion portion come into contact with each other by the insertion portion being inserted into the opening.

3. The liquid ejecting device according to claim 1, wherein
the main body side engaging portion includes the insertion portion, and
the liquid supply device side engaging portion includes the accommodating portion.

4. The liquid ejecting device according to claim 1, comprising:
a first locking member disposed so as to be spaced from the insertion portion at the one of the main body side engaging portion and the liquid supply device side engaging portion, and extending in the vertical direction; and
a second locking member disposed so as to be spaced from the accommodating portion at the other of the main body side engaging portion and the liquid supply device side engaging portion and configured such that movement relative to the first locking member is locked.

5. The liquid ejecting device according to claim 4, wherein
the first locking member and the second locking member are configured to come into contact with each other to regulate separation of the main body and the liquid supply device.

6. The liquid ejecting device according to claim 4, wherein
a surface treatment method for the insertion portion and a surface treatment method for the first locking member are different from each other.
